(19) United States
(12) Patent Application Publication
(10) Pub. No.: US 2020/0285451 A1
(43) Pub. Date: Sep. 10, 2020

(54) DECOUPLING MICROSERVICES FROM A MONOLITHIC APPLICATION

(71) Applicant: SAP SE, Walldorf (DE)

(72) Inventor: Mehul Agarwal, Ghaziabad (IN)

(21) Appl. No.: 16/292,744

(22) Filed: Mar. 5, 2019

(51) Int. Cl. G06F 8/36; G06F 8/60

(52) U.S. Cl. CPC G06F 8/36; G06F 8/60

(57) ABSTRACT

Provided is a system and method for extracting microservices from a monolithic application. The microservices are self-sufficient services which can be executed independently from the monolithic application. In one example, the method may include receiving an identification of a function from among a plurality of functions of a monolithic software application, extracting code of the identified function from the monolithic software application based on internal dependencies within code of the monolithic software application, generating a decoupled microservice based on the extracted code which executes the identified function independently from the monolithic software application, and storing the decoupled microservice for the identified function via a storage device.

### BACKGROUND

Traditional software development processes usually result in teams of engineers working on a single, monolithic deployment artifact (e.g., monolithic application, etc.) The resulting monolithic application is packaged into a single logical executable file. Although built as a single unit, the monolithic application typically includes multiple parts. Examples of these parts include a database (e.g., tables in a relational database management system), a client-side user interface (e.g., HTML pages and/or JavaScript running in a web browser), and a server-side application. The server-side application may handle HTTP requests, execute domain-specific logic, retrieve and update data from the database, populate the HTML views to be sent to the web browser, and the like. To make any alterations to the system, a developer must build and deploy an updated version of the server-side application.

By contrast, micro service architecture (micro services) is a method of developing software systems by building single-function modules with well-defined interfaces and operations. Microservices solve some of the challenges of monolithic systems because they are more modular. In the simplest form, they help build an application as a suite of small services, each running in its own process and independently deployable. These services may be written in different languages and may use different data storage techniques. The same service can be reused in more than one business process or over different business channels or digital touchpoints, depending on need. Dependencies between services and their consumer are minimized by applying the principle of loose coupling. By standardizing on contracts expressed through business-oriented APIs, consumers are not impacted by changes in the implementation of the service. This allows service owners to change the implementation and modify the systems of record or service compositions which may lie behind the interface and replace them without any downstream impact.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a system for generating a plurality of decoupled microservices from a monolithic application in accordance with an example embodiment.

FIG. 2 is a diagram illustrating a process of decomposing application code into microservices code in accordance with an example embodiment.

FIG. 3 is a diagram illustrating various backend examples of scaling-up services in accordance with an example embodiment.

FIG. 4 is a diagram illustrating a user interface for extracting a microservice in accordance with an example embodiment.

FIG. 5 is a diagram illustrating a method of extracting a microservice from a monolithic application in accordance with an example embodiment.

FIG. 6 is a diagram illustrating a computing system for use in the examples herein in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

Cloud applications typically include all functionality in one package (monolithic application) which is uploaded to the cloud and provided to users thereof. Monolithic applications are designed to perform every function needed to complete a particular task and not just individual functions of the task. Maintaining monolithic applications can be difficult in terms of effort and cost. Therefore, organizations are trending from on-premises hosting based on a monolithic architecture to a cloud-based solution which is based on a microservice architecture. In order to migrate a monolithic application to the cloud, the developer/engineer must create a new application using a microservices architecture. Essentially, the developer/engineer must redo the whole implementation from scratch. This can take significant manpower and time.

Monolithic applications also suffer from other drawbacks. For example, adoption of a new technology (even if minimal) can create significant impact throughout the application as a whole requiring large-scale code modifications. Furthermore, scalability or scaling of the monolithic application requires creating new instances of the application as a whole (with all of its different functionality) even when only a small subset of functions create the need for additional resources (scaling-up).

The example embodiments provide a solution for developers and engineers of monolithic applications by providing a tool which can decouple a microservice (specific function) from a monolithic application. The decoupling results in a microservice that is self-sufficient and capable of independently operating without reliance on the monolithic application. A monolithic application may have numerous functions (e.g., 10, 20, or more) which can individually be decoupled from the monolithic application and stored as a separate executable or in a library where it can be called by other applications, services, programs, etc. Furthermore, when a developer desires to migrate a monolithic application to a cloud platform, or the like, the tool described herein may be used to convert the monolithic code into a plurality of microservices without the need for a user to change the initial monolithic code. As a result, significant time and resources can be saved.

Monolithic applications may be structured using classes and packages that can be coherent and even decoupled at a source level but which may not be split into separate modules for compilation. In an allocation-based monolith, all of the code may be shippedideployed at the same time. In other words, once the compiled code is ‘ready for release’ then a single version is shipped to all nodes running the code. All running components have the same version of the software running at any point in time. In some cases, a developer may compile the entire codebase at once before deployment or may create a set of deployment artifacts from multiple sources and versions. In a runtime-based monolith, a single application or process performs the work for the system (although the system may have multiple, external dependencies).

By contrast, microservice capabilities are expressed formally with business-oriented APIs. Microservices may encapsulate a core business capability (e.g., a shopping cart, etc.) The implementation of the micro service, which may involve integrations with systems of record, may be hidden as the interface may be defined purely in business terms. Further, the same microservice can be reused in more than one business process or over different business channels or digital touchpoints, depending on need. Dependencies between services and their consumer are minimized by applying the principle of loose coupling. By standardizing on contracts expressed through business-oriented APIs, consumers are not impacted by changes in the implementation of the service. This allows service owners to change the implementation and modify the systems of record or service compositions which may lie behind the interface and replace them without any downstream impact.

The example embodiments may extract functionality from a monolithic application and create a microservice based thereon. The system described herein may receive an application package (monolithic application) and an identifier of a function or class associated with the application which is to be extracted. The identifier may be a uniform resource locator (URL) of a web-based application, a class name, etc. Using dependencies within the code of the monolithic application, the system can extract all functionality for implement a respective function and generate an independently (self-sufficient) executable for the functionality, in the form of a micro service. The microservice can then be used on its own without relying on the monolithic application during execution.

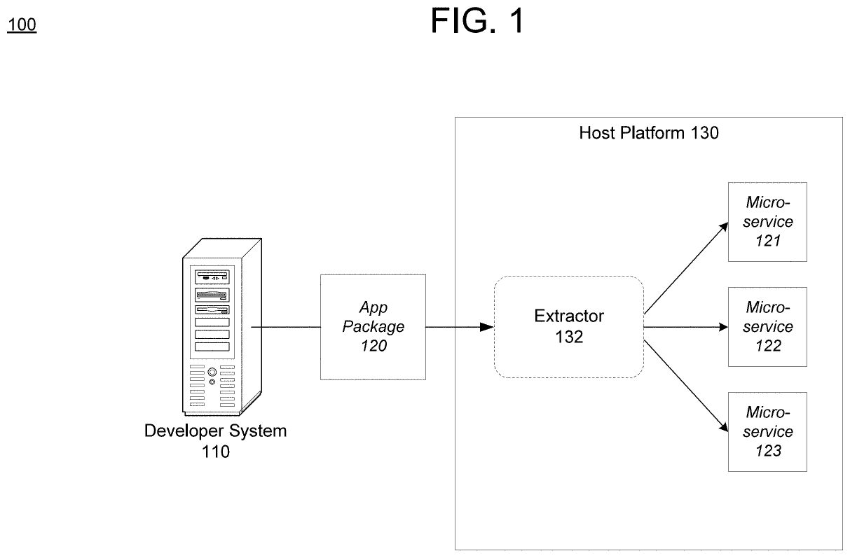

FIG. 1 illustrates a system 100 which can generate a plurality of decoupled microservices from a monolithic application in accordance with an example embodiment. Referring to FIG. 1, the system 100 includes a developer system 110 which uploads a monolithic application 120 to a host platform 130. For example, the host platform 130 may be a web server, a cloud platform, a database, a user device, and the like. The monolithic application 120 may include a single-tiered executable file which contains program code for multiple functions performed by the monolithic application 120.

As an example, the monolithic application 120 may include a include a database tables (e.g., relational database tables, etc.), a client-side user interface (e.g., HTML pages, JavaScript, etc., running in a web browser), and a server-side application. The server-side application may handle HTTP requests, execute domain-specific logic, retrieve and update data from the database, populate the HTML views to be sent to the web browser, and the like. The monolithic application may include a user interface (with various functions), a plurality of processes/functions for accessing and storing data from an underlying database, a plurality of processes/functions for interacting with web requests, and the like.

According to various embodiments, the host platform 130 may extract microservices out of the monolithic application 120 corresponding to the plurality of functions of the monolithic application 120. Each microservice can correspond to a particular functionality of the monolithic application 120 without functionality of the other functions of the monolithic application 120, which can be separately instantiated and self-sufficient for performing a function of the monolithic application 120. In this example, an extractor 132 may pull out a copy of code from the monolithic application 120 corresponding to a particular function and generate a self-sufficient microservice for independently performing the function. In the example of FIG. 1, the extractor 132 generates three microservices 121, 122, and 123. Each of the three microservices 121, 122, and 123 may correspond to different services/functions of the monolithic application 120 and may be performed as stand-alone services.

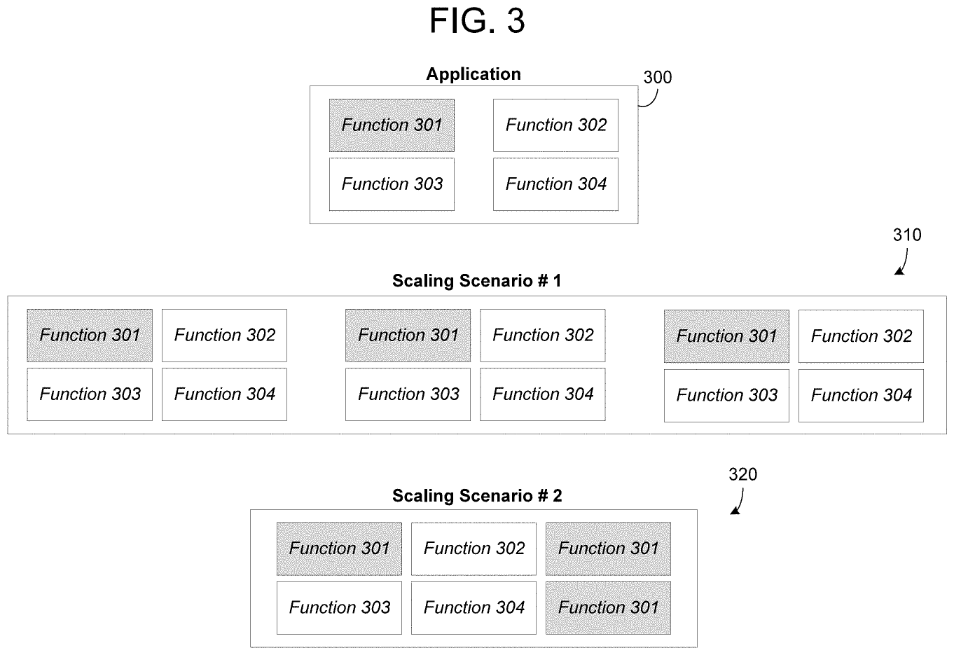

The host platform 130 may be optimize the use of resources from the very beginning of the development (e.g., when the monolithic application 120 is first uploaded to the host platform 130, etc.) by reducing the development hours, server resources, and the like, for converting the monolithic application 120 into a microservices architecture. Furthermore, as shown in the example of FIG. 3, the host platform 130 may also provide more effective scaling of the application on cloud, etc., when there is a need to scale-up the monolithic application 120 to include the ability to handle more requests. Furthermore, incorporation or adoption of new technology becomes simpler as it is easy to change a less complex framework and the changes will not affect the whole application as is the case for a monolithic architecture. In some embodiments, the extracted microservices 121, 122, and 123 may be made as a library which can be used by numerous applications.

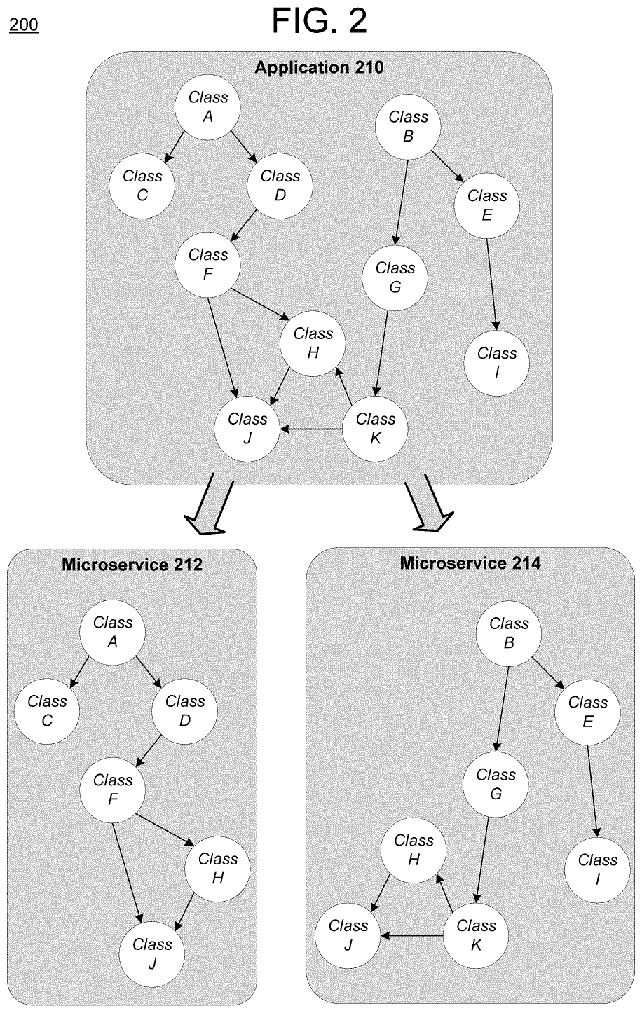

FIG. 2 illustrates a process 200 of decomposing application code of a monolithic application 210 into microservices 212 and 214 in accordance with an example embodiment. Referring to FIG. 2, the monolithic application 210 is represented as a dependency chart of software modules (e.g., classes). The system herein can be used to decouple a set of code components from the monolithic application 210 which represents complete functionality of a microservice. The decoupled microservice can be used within a microservice application corresponding the monolithic application 210, another microservice application, as a stand-alone service, within a library of services used by other applications, and the like. In this example, the monolithic application 210 is represented as a dependency chart with multiple modules 211 (which in this example are classes of code).

In the example of FIG. 2, the system can decouple two microservices service 212 and 214 from the monolithic application 210. Each microservice 212 and 214 may correspond to different functions performed by the monolithic application 210. In this example, the head (parent class) of microservice 212 is class A while the head of microservice 214 is class B. The system may identify which dependent nodes (child nodes) are included in each of the microservices 212 and 214, based on internal dependency of the head nodes class A and class B, respectively.

In this example, the system may determine that a first function A includes classes A, C, D, F, H, and J based on code-dependencies included in the monolithic application 210. Accordingly, the system may extract classes A, C, D, F, H, and J, along with their internal dependencies, and create a self-sufficient microservice 212 that performs the same functionality. Likewise, the system may determine that a second function B includes classes B, E, G, H, I, J, and K. Accordingly, the system may extract classes B, E, G, H, I, J, and K from the monolithic application and crate a self-sufficient microservice 214 for the second function.

In this example, classes H and J are determined to be included in both the first function and the second function. In other words, class H and J have code that overlaps in both the first function and the second function. Accordingly, the system may store a copy of classes H and J in the code for both the microservices 212 and 214. Accordingly, even though the microservices 212 and 214 share some overlapping code, the two microservices 212 and 214 may be performed/executed independently and separately from one another. That is, the separated microservices 212 and 214 are independent and are self-sufficient and can be used as a microservice or even imported as a library for other applications.

FIG. 3 illustrates different scaling scenarios for a monolithic application 300, in accordance with an example embodiment. Referring to the example of FIG. 3, the monolithic application 300 includes four different functionalities as follows:

Function 301=code editing

Function 302=logging

Function 303=database read-write

Function 304=code compiler

It is common for monolithic applications to offer different functionalities in one larger package of software. In this example, the application 300 may be hosted by a host platform (e.g., platform 130 in FIG. 1, etc.) which may be a cloud platform, a web server, a database, and the like. In the example of FIG. 3, a most commonly used functionality by clients of the host platform is the code editing function 301. In order to scale-up the monolithic application 300 to satisfy request/access of the code editing function 301, the host platform must create additional instances of the application 300 as a whole including running instances of all of the four functions 301, 302, 303, and 304, resulting in three separate instances of the monolithic application as shown in scenario 310. For optimal usage, the host platform is required to scale the whole application in its entirety to enable the code editing function 301 to work seamlessly. Therefore, all application functionalities are getting a new instance every time a new instance is needed for the code editing function 301.

Meanwhile, a second scenario 320 illustrates a significant saving in resources through the use of the micro services extraction tool described herein. In this example, rather than create additional copies of the monolithic application 300 in its entirety, the system can extract the functionality of the code editing function 301 on its own and create additional running instances of the code editing function 301 alone, instead of creating additional instances of the monolithic application 300 (and functions 301-304) in its entirety. Furthermore, even when the code editing function 301 shares code modules with other functions (e.g., functions 302-304) of the monolithic application, the code editing function 301 can be independently executed and self-sufficient by extracting all necessary code dependencies from the monolithic application 300 including those code modules that overlap. As a result, scenario 320 requires significantly less processing resources and bandwidth than scenario 310 while still addressing the same issue of scaling-up the code editing function 301.

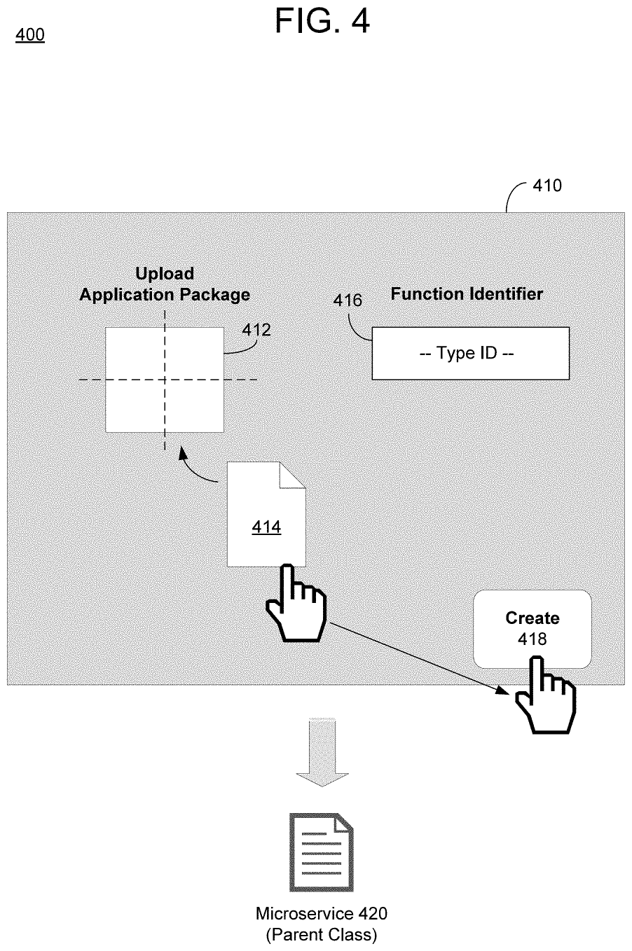

FIG. 4 illustrates a process 400 for extracting a microservice in accordance with an example embodiment. Referring to FIG. 4, a user interface 410 may be hosted by a cloud platform, web server, or other host. In this example, the user uploads an application package 414 through an upload window 412 of the user interface 410 during process 400. In this example, the application package 414 may include an executable file of a monolithic application. The user may input an identifier (e.g., a class name, etc.) into a function identifier input field 416 to thereby provide functionality that the user desires to extract from the application package 414. Furthermore, the user interface 410 may include a create button 418 which when pressed by the user during process 400 creates a microservice 420 based on the input identifier. The microservice 420 may include executable code/service for the functionality identified through the function identifier input field 416.

However, it should be appreciated that the monolithic application 412 may already be uploaded and running on the host platform. In this alternative example, the user could provide a URL of the functionality that the user desires to extract. In this example, the function identifier input field 416 could receive a URL of a web page where the functionality is hosted by the system. In response, the system could extract the functionality from an already stored application on the host platform, and create the microservice 420.

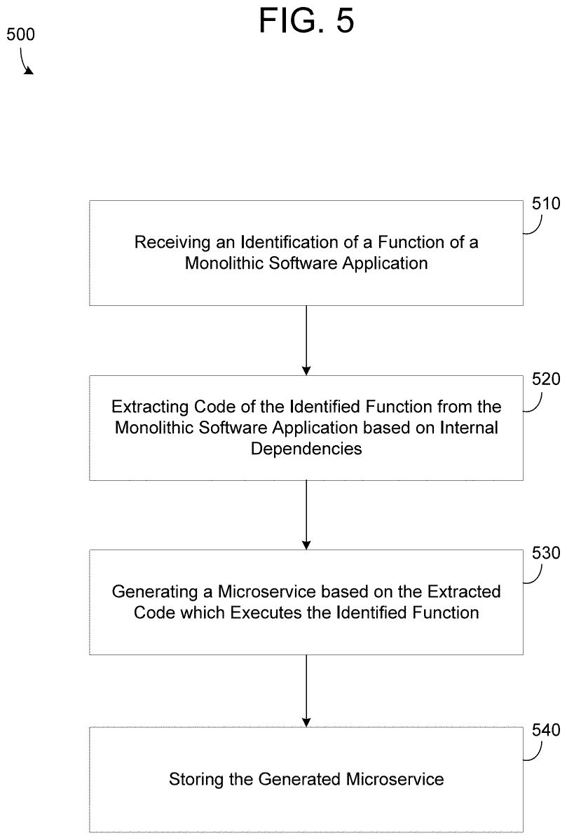

FIG. 5 illustrates a method 500 of extracting a microservice from a monolithic application in accordance with an example embodiment. For example, the method 500 may be performed by a database node, a cloud platform, a server, a computing system (user device), a combination of devices/nodes, or the like. Referring to FIG. 5, in 510, the method may include receiving an identification of a function from among a plurality of functions of a monolithic software application. For example, the identification of the function may be a URL of a web page of the monolithic software application, a class name (parent class) of the monolithic software application, and the like. In this example, the class name may identify a class from among a plurality of classes included in the monolithic software function. The identification may be detected from input via a user interface such as through a predefined field, button, drop-down menu, or the like.

In 520, the method may include extracting code of the identified function from the monolithic software application based on internal dependencies within code of the monolithic software application. For example, the extracting may include creating a copy of the code of the monolithic application which corresponds to the particular function without including other code in the monolithic application which is not directed to the identified function. However, in some cases, the code for two different functions may partially overlap. In this case, the method may include extracting all code (including the overlapping code with the other function).

In some embodiments, the extracting may include extracting the code of the identified function based on class-dependencies of the input class name in the monolithic software application. In some embodiments, the extracting may include extracting a copy of modules of code from the monolithic software application corresponding to the identified function while ignoring modules of code corresponding to other functions. In some embodiments, the extracting may include extracting code modules from an executable package of the monolithic software application that have overlapping internal dependencies with another function from among the plurality of functions of the monolithic software application.

In 530, the method may include generating a decoupled microservice based on the extracted code which executes the identified function independently from the monolithic software application, and in 540, storing the decoupled microservice for the identified function via a storage device. According to various aspects, the decoupled microservice may include a separately executable software program configured to execute the identified function without depending on the monolithic software application. That is, the decoupled microservice may be self-sufficient. In some embodiments, the method may further include deploying additional running instances of the generated microservice in response to a scale-up request. In some embodiments, the method may further include transmitting the generated microservice to user device such as a developer or storing the microservice in a library for use by other software application on the platform.

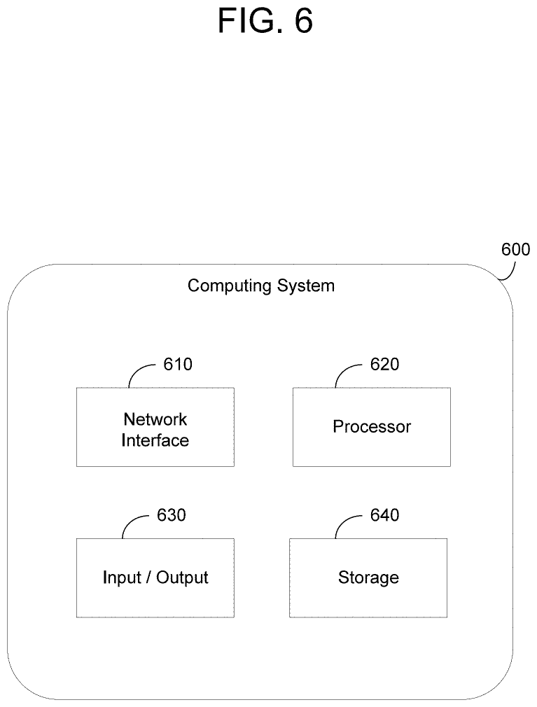

FIG. 6 illustrates a computing system 600 that may be used in any of the methods and processes described herein, in accordance with an example embodiment. For example, the computing system 600 may be a database node, a server, a cloud platform, or the like. In some embodiments, the computing system 600 may be distributed across multiple computing devices such as multiple database nodes. Referring to FIG. 6, the computing system 600 includes a network interface 610, a processor 620, an input/output 630, and a storage device 640 such as an in-memory storage, and the like. Although not shown in FIG. 6, the computing system 600 may also include or be electronically connected to other components such as a display, an input unit(s), a receiver, a transmitter, a persistent disk, and the like. The processor 620 may control the other components of the computing system 600.

The network interface 610 may transmit and receive data over a network such as the Internet, a private network, a public network, an enterprise network, and the like. The network interface 610 may be a wireless interface, a wired interface, or a combination thereof. The processor 620 may include one or more processing devices each including one or more processing cores. In some examples, the processor 620 is a multicore processor or a plurality of multicore processors. Also, the processor 620 may be fixed or it may be reconfigurable. The input/output 630 may include an interface, a port, a cable, a bus, a board, a wire, and the like, for inputting and outputting data to and from the computing system 600. For example, data may be output to an embedded display of the computing system 600, an externally connected display, a display connected to the cloud, another device, and the like. The network interface 610, the input/output 630, the storage 640, or a combination thereof, may interact with applications executing on other devices.

The storage device 640 is not limited to a particular storage device and may include any known memory device such as RAM, ROM, hard disk, and the like, and may or may not be included within a database system, a cloud environment, a web server, or the like. The storage 640 may store software modules or other instructions which can be executed by the processor 620 to perform the method shown in FIG. 5. According to various embodiments, the storage 640 may include a data store having a plurality of tables, partitions and sub-partitions. The storage 640 may be used to store database records, items, entries, and the like.

According to various embodiments, the processor 620 may receive an identification of a function from among a plurality of functions of a monolithic software application. For example, the processor 620 may detect an input via a user interface such as an input class name, a URL of a cloud application, and the like. The processor 620 may extract code of the identified function from the monolithic software application based on internal dependencies within the code of the monolithic software application. The processor 620 may generate a decoupled microservice based on the extracted code which executes the identified function independently (i.e., separate and self-sufficient) from the monolithic software application. The storage 640 may store the decoupled microservice for the identified function.

In some embodiments, the processor 620 may extract the code of the identified function based on class-dependencies of the input class name in the monolithic software application. For example, the processor 620 may extract a copy of modules of code from the monolithic software application corresponding to the identified function and ignore modules of code corresponding to other functions. In some embodiments, the processor 620 may extract code modules from an executable package of the monolithic software application that have overlapping internal dependencies with another function from among the plurality of functions of the monolithic software application. In some embodiments, the processor 620 may deploy additional running instances of the decoupled micro service in response to receiving a scale-up request.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

1. A computing system comprising:
a processor configured to
receive text input comprising a network address of a monolithic software application that has been uploaded to a host platform for execution, and a class name from among a plurality of classes of the monolithic software application,
extract code of a class identified by the text input of the class name and code of a plurality of dependent classes that depend from the class from a storage location of the monolithic software application identified from the network address based on internal dependencies within code of the monolithic software application, and
generate a decoupled microservice based on the extracted code which executes the identified function independently from the monolithic software application; and
a storage configured to store the decoupled microservice for the identified function.

2. The computing system of claim 1, wherein the processor is configured to receive input of a uniform resource location (URL) which identifies a web page of the monolithic software application.

3. The computing system of claim 1, wherein the processor is configured to receive, via a text input field of a user interface, the class name included in the monolithic software function.

4. (canceled)

5. The computing system of claim 1, wherein the processor is configured to extract a copy of modules of code from an executable package of the monolithic software application corresponding to the identified function and ignore modules of code corresponding to other functions.

6. The computing system of claim 1, wherein the processor is configured to extract code modules from an executable package of the monolithic software application that have overlapping internal dependencies with another function from among the plurality of functions of the monolithic software application.

7. The computing system of claim 1, wherein the decoupled microservice comprises a separately executable software program configured to execute the identified class without depending on the monolithic software application.

8. The computing system of claim 1, wherein the processor is further configured to deploy additional running instances of the decoupled microservice in response to receiving a scale-up request.

9. A method comprising:
receiving text input comprising a network address of a monolithic software application that has been uploaded to a host platform for execution, and a class name from among a plurality of classes of the monolithic software application;
extracting code of a class identified by the text input of the class name and code of a plurality of dependent classes that depend from the class from a storage location of the monolithic software application identified from the network address based on internal dependencies within code of the monolithic software application;
generating a decoupled microservice based on the extracted code which executes the identified function independently from the monolithic software application; and
storing the decoupled microservice for the identified function via a storage device.

10. The method of claim 9, wherein the receiving comprises receiving a uniform resource location (URL) of a web page of the monolithic software application.

11. The method of claim 9, wherein the receiving comprises receiving, via a text input field of a user interface, the class name included in the monolithic software function.

12. (canceled)

13. The method of claim 9, wherein the extracting comprises extracting a copy of modules of code from an executable package of the monolithic software application corresponding to the identified function while ignoring modules of code corresponding to other functions.

14. The method of claim 9, wherein the extracting comprises extracting code modules from an executable package of the monolithic software application that have overlapping internal dependencies with another function from among the plurality of functions of the monolithic software application.

15. The method of claim 9, wherein the decoupled microservice comprises a separately executable software program configured to execute the identified class without depending on the monolithic software application.

16. The method of claim 9, further comprising deploying additional running instances of the generated microservice in response to a scale-up request.

17. A non-transitory computer-readable medium storing instructions which when executed cause a computer to perform a method comprising:
receiving text input comprising a network address of a monolithic software application that has been uploaded to a host platform for execution, and a class name from among a plurality of classes of the monolithic software application;
extracting code of a class identified by the text input of the class name and code of a plurality of dependent classes that depend from the class from a storage location of the monolithic software application identified from the network address based on internal dependencies within code of the monolithic software application;
generating a decoupled microservice based on the extracted code which executes the identified function independently from the monolithic software application; and
storing the decoupled microservice for the identified function via a storage device.

18. The non-transitory computer-readable medium of claim 17, wherein the extracting comprises extracting a copy of modules of code from an executable package of the monolithic software application corresponding to the identified function while ignoring modules of code corresponding to other functions.

19. The non-transitory computer-readable medium of claim 17, wherein the extracting comprises extracting code modules from an executable package of the monolithic software application that have overlapping internal dependencies with another function from among the plurality of functions of the monolithic software application.

20. The non-transitory computer-readable medium of claim 17, wherein the decoupled microservice comprises a separately executable software program configured to execute the identified class without depending on the monolithic software application.

21. The computing system of claim 1, wherein the processor is further configured to extract the internal dependencies of the plurality of dependent classes from the code of the uploaded monolithic software application, and generate the decoupled microservice based on the extracted internal dependencies of the plurality of dependent classes.

22. The computing system of claim 1, wherein the processor is further configured to extract a second class identified and code of a second plurality of dependent classes that depend from the second class, wherein the extracted code of the second plurality of dependent classes share at least one class in common with the extracted plurality of dependent classes of the class.
